(19) United States
(12) Patent Application Publication
(10) Pub. No.: US 2026/0142307 A1
(43) Pub. Date: May 21, 2026

(54) BATTERY MODULE AND BATTERY PACK COMPRISING THE SAME

(71) Applicant: SK On Co., Ltd., Seoul (KR)

(72) Inventors: Jin Po PARK, Daejeon (KR); Hui Jun SHIN, Daejeon (KR); Hoe Wook CHOI, Daejeon (KR); Chong Pyo HONG, Daejeon (KR); Dae Gyun HWANG, Daejeon (KR)

(21) Appl. No.: 19/392,145

(22) Filed: Nov. 18, 2025

(30) Foreign Application Priority Data
Nov. 19, 2024 (KR) 10-2024-0164914

(51) Int. Cl. H01M 50/291; H01M 10/48; H01M 50/211; H01M 50/293; H01M 50/503; H01M 50/519; H01M 50/522

(52) U.S. Cl. CPC H01M 50/291; H01M 10/482; H01M 50/211; H01M 50/293; H01M 50/503; H01M 50/519; H01M 50/522

(57) ABSTRACT

A battery module includes a cell assembly including a plurality of battery cells, each including at least one electrode lead, a module housing accommodating the cell assembly, a busbar assembly including a busbar bonded to the electrode leads of the cell assembly and a busbar frame supporting the busbar, and a sensor assembly at least partially disposed on the busbar frame. The sensor assembly may include a flexible printed circuit board including a metal layer including a bent region bonded to the busbar and an insulating layer covering at least a portion of the metal layer.

### CROSS-REFERENCE TO RELATED APPLICATION(S)

This patent document claims the priority and benefits of Korean Patent Application No. 10-2024-0164914 filed on Nov. 19, 2024, the disclosure of which is incorporated herein by reference in its entirety.

### TECHNICAL FIELD

The disclosure and implementations disclosed in this patent document generally relate to a battery module and a battery pack including the same.

### BACKGROUND

Unlike primary batteries, secondary batteries may be charged with and discharged of electricity, and thus, may be applied to devices within various fields, such as digital cameras, mobile phones, laptops, hybrid vehicles, electric vehicles, and energy storage systems (ESS). Secondary batteries may be lithium-ion batteries, nickel-cadmium batteries, nickel-metal hydride batteries, or nickel-hydrogen batteries.

Secondary batteries are manufactured as flexible pouch-type battery cells or rigid prismatic or cylindrical can-type battery cells. A plurality of battery cells may be arranged in a module housing to form a battery module.

### SUMMARY

A battery module may include a cell assembly, a busbar assembly, and a sensor assembly. The sensor assembly may include a sensing terminal connected to a busbar of the busbar assembly. However, welding the sensing terminal and busbar may require soldering and coating processes.

The present disclosure may be implemented in some embodiments to provide a battery module with reduced manufacturing costs.

The present disclosure may also be implemented in some embodiments to provide a battery module with a simplified manufacturing process.

The battery module and battery pack of the present disclosure may be widely applied to green technology fields, such as electric vehicles, battery charging stations, and solar power generation and wind power generation using batteries. In addition, the battery module and battery pack of the present disclosure may be used in eco-friendly electric vehicles and hybrid vehicles to ameliorate the effects of climate change by suppressing air pollution and greenhouse gas emissions.

In some embodiments of the present disclosure, a battery module includes: a cell assembly including a plurality of battery cells, each including at least one electrode lead; a module housing accommodating the cell assembly; a busbar assembly including a busbar bonded to the electrode leads of the cell assembly and a busbar frame supporting the busbar; and a sensor assembly at least partially disposed on the busbar frame. The sensor assembly may include a flexible printed circuit board including a metal layer including a bent region bonded to the busbar and an insulating layer covering at least a portion of the metal layer.

The metal layer may include an end region located on one side of the bent region and a connection region located on the other side of the bent region. The insulating layer may include a first cover region covering the end region and a second cover region covering the connection region.

The metal layer may include a first surface and a second surface, opposite to the first surface. The first surface may be folded such that at least a portion of the first surface contacts each other. At least a portion of the second surface may be bonded to the busbar.

The first cover region may include a first insulating layer covering the first surface of the end region and a second insulating layer covering the second surface of the end region. The second cover region may include a third insulating layer covering the first surface of the connection region and a fourth insulating layer covering the second surface of the connection region.

The first insulating layer may be in contact with the third insulating layer.

The insulating layer may include an upper through-hole exposing the first surface of the metal layer and a lower through-hole exposing the second surface of the metal layer.

A first diameter of the upper through-hole may be smaller than a second diameter of the lower through-hole.

The upper through-hole may include a first upper through-hole and a second upper through-hole spaced apart from each other. The lower through-hole may include a first lower through-hole and a second lower through-hole spaced apart from each other. The first upper through-hole, the second upper through-hole, the first lower through-hole, and the second lower through-hole may be arranged to overlap each other.

The metal layer may include copper. The insulating layer may include polyimide.

The plurality of battery cells may each include an electrode assembly connected to the electrode leads of the cell assembly and a pouch accommodating the electrode assembly.

The sensor assembly may include a connection portion electrically connected to the flexible printed circuit board and an insulating portion preventing contact between the connection portion and the cell assembly.

In some embodiments of the present disclosure, a battery module includes a plurality of battery cells; a busbar electrically connected to at least one of the plurality of battery cells; and a flexible printed circuit board connected to the busbar and including a metal layer including a bent region folded along a folding line and an insulating layer covering the metal layer such that at least a portion of the bent region may be exposed, wherein the at least a portion of the bent region exposed from the insulating layer is in contact with the busbar.

The metal layer may include a first surface opposite to the busbar and a second surface, opposite to the first surface and facing the busbar, and the first surface of the bent region may be folded such that at least a portion of the first surface contacts each other in a facing manner.

The insulating layer may include an upper through-hole exposing at least a portion of the first surface of the bent region and a lower through-hole exposing at least a portion of the second surface of the bent region, and the second surface of the bent region exposed through the lower through-hole may contact the busbar.

In some embodiments of the present disclosure, a battery pack includes a plurality of battery modules; and a pack frame accommodating the plurality of battery modules. The battery module may include a cell assembly including a plurality of battery cells, each including at least one electrode lead; a module housing accommodating the cell assembly; a busbar assembly including a busbar bonded to the electrode leads of the cell assembly and a busbar frame supporting the busbar; and a sensor assembly disposed on the busbar frame. The sensor assembly may include a flexible printed circuit board including a metal layer including a bent region bonded to the busbar and an insulating layer covering at least a portion of the metal layer.

The metal layer may include a first surface opposite to the busbar and a second surface, opposite to the first surface and facing the busbar, and the first surface of the bent region may be folded such that at least a portion of the first surface contacts each other in a facing manner.

The insulating layer may include an upper through-hole exposing at least a portion of the first surface of the bent region and a lower through-hole exposing at least a portion of the second surface of the bent region, and the second surface of the bent region exposed through the lower through-hole may contact the busbar.

### BRIEF DESCRIPTION OF DRAWINGS

Certain aspects, features, and advantages of the present disclosure are illustrated by the following detailed description with reference to the accompanying drawings.

FIG. 1 is a perspective view of a battery cell according to an embodiment;

FIG. 2 is a perspective view of a battery module according to an embodiment;

FIG. 3 is an exploded perspective view of a battery module according to an embodiment;

FIG. 4 is a front view illustrating welding of a flexible printed circuit board and a busbar according to an embodiment;

FIG. 5 is a cross-sectional view taken along line I-I′ of FIG. 4, according to an embodiment;

FIG. 6A is a diagram illustrating a process of connecting a sensor assembly and a busbar, according to an embodiment;

FIG. 6B is a cross-sectional view taken along line II-II′ of FIG. 6A;

FIG. 7 is a diagram illustrating a process of connecting a sensor assembly and a busbar, according to another embodiment; and

FIG. 8 is an exploded perspective view of a battery pack, according to an embodiment.

### DETAILED DESCRIPTION

The present disclosure will be described in detail with reference to the accompanying drawings. However, this is merely illustrative and the present disclosure is not limited to the specific embodiments described by way of example.

Terms and words used in the present specification and claims to be described below should not be construed as limited to ordinary or dictionary terms, and should be construed in accordance with the technical idea of the present disclosure based on the principle that the inventors may properly define their own disclosures in terms of terms in order to best explain the disclosure.

Therefore, the embodiments described in the present specification and the configurations illustrated in the drawings are merely the most preferred embodiments of the present disclosure and are not intended to represent all of the technical ideas of the present disclosure, and thus should be understood that various equivalents and modifications may be substituted at the time of the present application.

Hereinafter, embodiments of the present disclosure will be described in detail with reference to the accompanying drawings. In this case, in the drawings, the same components are denoted by the same reference symbols as possible. Further, the detailed description of well-known functions and constructions which may obscure the gist of the present disclosure will be omitted. Some of the elements in the accompanying drawings are exaggerated, omitted, or schematically illustrated, and the size of each element does not entirely reflect the actual size.

FIG. 1 is a perspective view of a battery cell according to an embodiment.

Referring to FIG. 1, a battery cell 100 may include an electrode assembly 120, a pouch 110 accommodating the electrode assembly 120, and an electrode lead 130 connected to the electrode assembly 120. The battery cell 100 may be a secondary battery. For example, the battery cell 100 may be a lithium ion battery, but is not limited thereto. For example, the battery cell 100 may be a nickel-cadmium battery, a nickel-metal hydride battery, or a nickel-hydrogen battery that may be recharged and discharged.

The pouch 110 may form at least a portion of the exterior of the battery cell 100. The pouch 110 may include an electrode accommodation portion 111 accommodating an electrode assembly 120 and a sealing portion 115 for sealing at least a portion of the periphery of the electrode accommodation portion 111. The electrode accommodation portion 111 may provide a space for accommodating the electrode assembly 120 and an electrolyte.

The sealing portion 115 may be formed by joining at least a portion of the periphery of the pouch 110. The sealing portion 115 may be formed in a flange shape extending outwardly from the electrode accommodation portion 111, which is formed in a container shape, and may be positioned along at least a portion of the outer portion of the electrode accommodation portion 111. In an embodiment, the sealing portion 115 may include a first sealing portion 115a in which the electrode lead 130 is positioned and a second sealing portion 115b in which the electrode lead 130 is not positioned. A portion of the electrode lead 130 may be drawn out or exposed outside the pouch 110.

In an embodiment, the battery cell 100 may include an insulating film 140. At the location in which the electrode lead 130 is drawn out, the electrode lead 130 may be covered by the insulating film 140 to increase the sealing of the first sealing portion 115a and simultaneously ensure electrical insulation. The insulating film 140 is formed of a thinner film material than the electrode lead 130 and may be attached to both sides of the electrode lead 130.

In an embodiment, the electrode leads 130 may be disposed on opposite sides of the battery cell 100 in the length direction of the battery cell 100 to face in opposite directions. For example, the electrode lead 130 may include a positive electrode lead 130a having a first polarity (e.g., a positive polarity) facing one side of the battery cell 100 in the length direction and a negative electrode lead 130b having a second polarity (e.g., a negative polarity) facing the other side of the battery cell 100 in the length direction. In the embodiment illustrated in FIG. 1, the sealing portion 115 may include two first sealing portions 115a on which the electrode lead 130 is disposed and one second sealing portion 115b on which the electrode lead 130 is not disposed. The electrode leads 130 may be referred to as electrode tabs.

The direction of the electrode leads 130 may be selectively designed. In an embodiment, the electrode leads 130 may include a positive electrode lead 130a and a negative electrode lead 130b disposed opposite to the positive electrode lead 130a with respect to the electrode assembly 120. In FIG. 1, the electrode leads 130 are illustrated arranged on opposite sides of the battery cell 100 in the length direction of the battery cell 100 and face in opposite directions, but the structure of the electrode leads 130 is not limited thereto. For example, two electrode leads 130 may be arranged substantially parallel in the length direction of the battery cell 100. Meanwhile, the pouch 110 is not limited to the structure illustrated in FIG. 1, in which a single sheet of outer casing is folded to form the sealing portion 115 on three sides.

In an embodiment of the present disclosure, at least a portion of the sealing portion 115 may be formed in a folded form at least once. By folding at least a portion of the sealing portion 115, the bonding reliability of the sealing portion 115 may be improved and the area of the sealing portion 115 may be minimized.

The electrode assembly 120 may include a cathode plate, an anode plate, and a separator. The separator may prevent contact between the cathode and anode plates. Those skilled in the art will appreciate that the electrode assembly 120 may be manufactured using various methods. According to embodiments, the electrode assembly 120 may be formed by repeatedly disposing a positive electrode (or a cathode), a negative electrode (or an anode), and the separator. In some embodiments, the electrode assembly 120 may be of a winding type, a stacking type, a z-folding type, or a stack-folding type.

The structure of the battery cell 100 illustrated in FIG. 1 is an example. For example, in FIG. 1, the battery cell 100 is described as a pouch-type battery cell, but the structure of the battery cell 100 is not limited thereto. For example, the battery cell 100 may be a cylindrical battery cell or a prismatic battery cell.

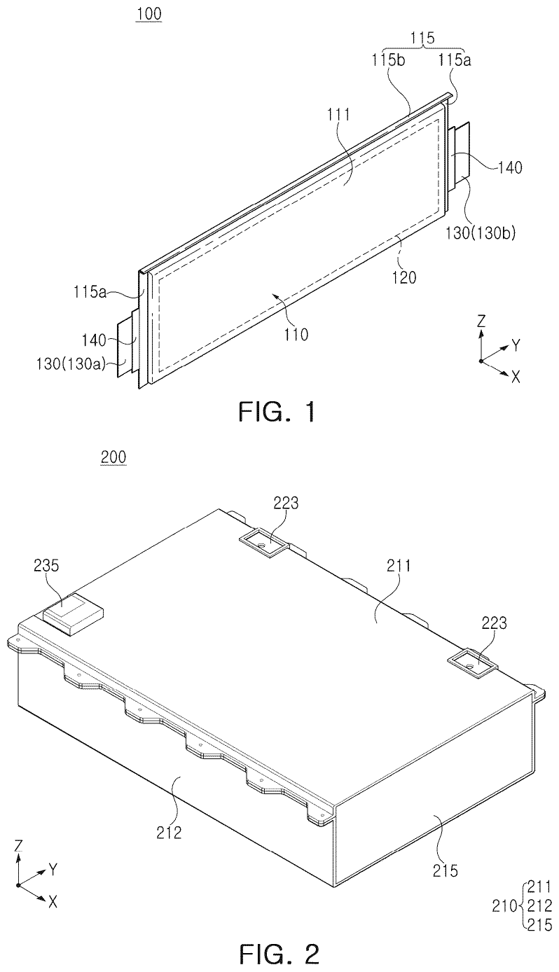

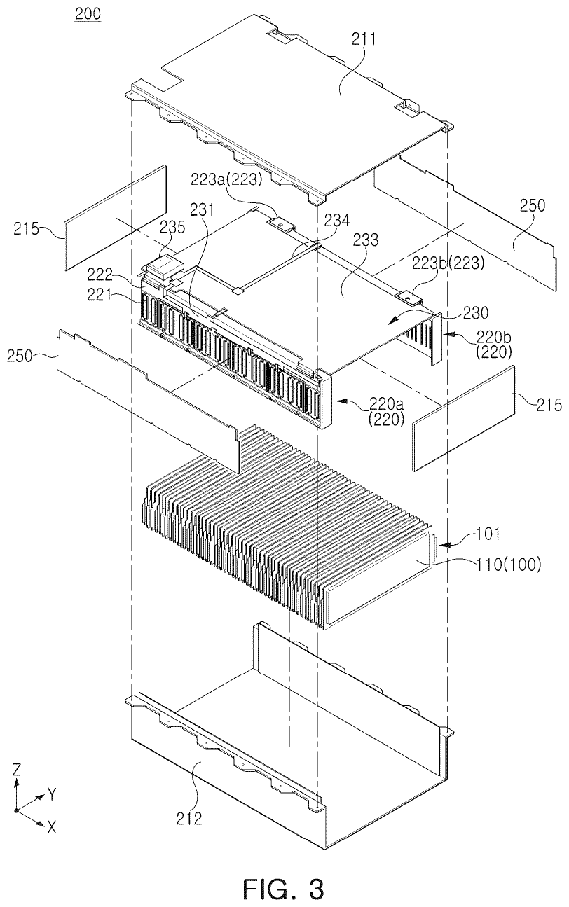

FIG. 2 is a perspective view of a battery module according to an embodiment. FIG. 3 is an exploded perspective view of the battery module according to an embodiment.

Referring to FIGS. 2 and/or 3, a battery module 200 may include a cell assembly 101 including a plurality of battery cells (e.g., the battery cell 100 of FIG. 1), a module housing 210 accommodating the cell assembly 101, a busbar assembly 220, and/or a sensor assembly 230.

The module housing 210 may form at least a portion of the exterior of the battery module 200. The module housing 210 may accommodate components of the battery module 200, such as the cell assembly 101 and the busbar assembly 220.

The module housing 210 may include a module cover 211. The module cover 211 may cover the cell assembly 101. The module cover 211 may be disposed on one side of the cell assembly 101. The module cover 211 may form at least a portion of the exterior of the battery module 200.

The module housing 210 may include an accommodation portion 212 accommodating the cell assembly 101. The accommodation portion 212 may surround the bottom surface and side surfaces of the cell assembly 101. In an embodiment, the accommodation portion 212 may include a main plate covering the bottom surface of the cell assembly and a plurality of sidewall members covering at least a portion of the side surfaces of the cell assembly 101. In an embodiment, the main plate and the sidewall member may be formed integrally.

The module housing 210 may include an end plate 215 covering a portion of the side surface of the cell assembly 101. In an embodiment, the end plate 215 may be connected to an end portion of the accommodation portion 212.

According to an embodiment, the module housing 210 may be formed of a material having high thermal conductivity, such as metal. For example, the module housing 210 may be formed of aluminum and/or stainless steel. However, the material of the module housing 210 is not limited thereto. In another embodiment, the module housing 210 may be formed of a polymer. In an embodiment, the module housing 210 may be referred to as a module case.

The shape of the module housing 210 of the present disclosure is an example.

The busbar assembly 220 may include a plurality of busbars 221. The busbars 221 may be electrically connected to a plurality of battery cells 100. For example, the busbar 221 may be joined to the electrode lead 130 of FIG. 1. Each of the plurality of battery cells 100 may include an electrode assembly (e.g., the electrode assembly 120 of FIG. 1), a pouch (e.g., the pouch 110 of FIG. 1) accommodating the electrode assembly 120, and an electrode lead (e.g., the electrode lead 130 of FIG. 1) connected to the electrode assembly 120. The electrode lead 130 may be welded to the busbar 221 while being inserted into a slit of the busbar 221. The busbar 221 may be referred to as an internal busbar.

The busbar assembly 220 may include a busbar frame 222 supporting the busbar 221. The busbar frame 222 may be referred to as a support plate or frame. The busbar frame 222 may be formed of an electrically insulating material (e.g., a polymer). At least a portion of the busbar frame 222 may be disposed between the cell assembly 101 and the busbar 221 to support the busbar 221. In an embodiment, the busbar 221 may be referred to as a busbar. In an embodiment, the busbar assembly 220 may include a first busbar assembly 220a located on one side of the cell assembly 101 and a second busbar assembly 220b located on the other side of the cell assembly 101.

The busbar assembly 220 may include at least one terminal busbar 223 for electrical connection to the exterior of the battery module 200. The electrode lead 130 of the battery cell 100 may be electrically connected to the exterior of the battery module 200 through the busbar 221 and the terminal busbar 223. For example, the terminal busbar 223 may be electrically connected to the busbar 221, and the current of the battery cell 100 may be transmitted to the exterior of the battery module 200 through the busbar 221 and the terminal busbar 223. At least a portion of the terminal busbar 223 may be exposed to the exterior of the module housing 210 (e.g., the module cover 211).

In an embodiment, the terminal busbar 223 may be provided in plural. For example, the terminal busbar 223 may include a first terminal busbar 223a having a first polarity (e.g., positive polarity) and a second terminal busbar 223b having a second polarity (e.g., negative polarity), different from the first polarity. The first terminal busbar 223a may be spaced apart from the second terminal busbar 223b.

The battery module 200 may include the sensor assembly 230. The sensor assembly 230 may detect information (e.g., temperature and/or voltage) of the battery cell 100. At least a portion of the sensor assembly 230 may be disposed on the busbar frame 222.

The sensor assembly 230 may include a flexible printed circuit board 231 configured to detect information from the busbar 221. The flexible printed circuit board 231 may cover a portion of the busbar frame 222. The flexible printed circuit board 231 may provide a path for signal transmission. The flexible printed circuit board 231 may be bonded to the busbar 221 and configured to detect information from the busbar 221. In an embodiment, the flexible printed circuit board 231 may detect the voltage and/or current of the battery cell 100.

In an embodiment, the sensor assembly 230 may include an insulating portion 233. The insulating portion 233 may prevent contact between the cell assembly 101 and a connection portion 234. The insulating portion 233 may be disposed between the cell assembly 101 and the connection portion 234 of the flexible printed circuit board 231.

The sensor assembly 230 may be disposed on the busbar frame 222. For example, the flexible printed circuit board 231 may be disposed on the busbar frame 222. In an embodiment, at least a portion of the flexible printed circuit board 231 may be replaced with a printed circuit board. In an embodiment, the flexible printed circuit board 231 may be disposed on each of the busbar frame 222 of the first busbar assembly 220a and the busbar frame 222 of the second busbar assembly 220b.

The signal detected by the sensor assembly 230 may be transmitted to the exterior of the battery module 200 via the flexible printed circuit board 231. The sensor assembly 230 may include a connector 235 electrically connected to the flexible printed circuit board 231. The connector 235 may be electrically connected to the exterior of the battery module 200.

The sensor assembly 230 may include the connection portion 234 electrically connected to the flexible printed circuit board 231. For example, the sensor assembly 230 may include the connection portion 234 connected to the flexible printed circuit board 231 disposed on the first busbar assembly 220a and the flexible printed circuit board 231 disposed on the second busbar assembly 220b. Electrical signals detected by the first busbar assembly 220a and the second busbar assembly 220b may be transmitted to the connector 235 via the connection portion 234. In an embodiment, the busbar assembly 220 may be assembled with the sensor assembly 230 and provided as a single component.

The battery module 200 may include an insulating cover 250 covering at least a portion of the busbar assembly 220. The insulating cover 250 may prevent damage to the busbar assembly 220 and/or the sensor assembly 230 due to external impact. The insulating cover 250 may prevent unintended electrical connection between the busbar assembly 220 and/or the sensor assembly 230.

The insulating cover 250 may prevent contact between the busbar 221 of the busbar assembly 220 and a conductive component (e.g., the module housing 210) and between the flexible printed circuit board 231 of the sensor assembly 230 and a conductive component (e.g., the module housing 210). The insulating cover 250 may be disposed between the accommodation portion 212 of the module housing 210 and the busbar assembly 220.

The insulating cover 250 may be formed of an insulating material. For example, the insulating cover 250 may include a flame-retardant polymer. In an embodiment, the insulating cover 250 may include flame-retardant polypropylene.

For convenience of description, some components are omitted or exaggerated in this document. For example, the number of battery cells 100, the shape of the module housing 210, and/or the shape of the busbar assembly 220 may be selectively designed.

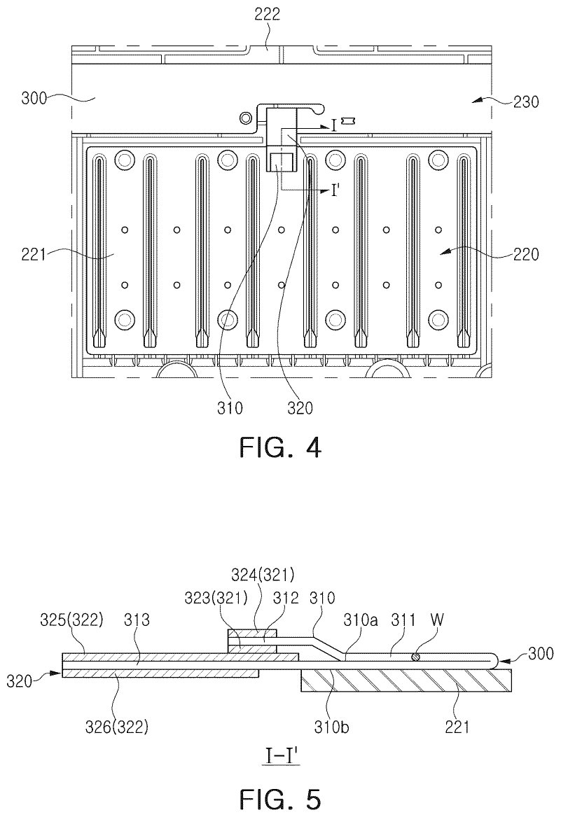

FIG. 4 is a front view illustrating welding of a flexible printed circuit board and a busbar according to an embodiment. FIG. 5 is a cross-sectional view taken along line I-I′ of FIG. 4 according to an embodiment.

Referring to FIGS. 4 and 5, a battery module of the present disclosure may include a plurality of battery cells 100, a busbar 221 electrically connected to at least one of the plurality of battery cells 100, and a flexible printed circuit board 300 including a metal layer 310 connected to the busbar 221 and including a bent region 311 folded along a folding line FL, and an insulating layer 320 covering the metal layer such that at least a portion of the bent region is exposed, and the portion of the bent region 311 exposed from the insulating layer may contact the busbar. Referring to the drawings, the bent regions 311 may be disposed such that at least a portion thereof overlaps each other when folded along the folding line FL. Details of the present disclosure will be described below.

Specifically, the battery module 200 may include the busbar assembly 220 including the busbar 221 and the busbar frame 222 and the sensor assembly 230 including a flexible printed circuit board 300. The descriptions of the battery module 200, the busbar assembly 220 (e.g., the busbar 221), and the sensor assembly 230 (e.g., the flexible printed circuit board 231) of FIGS. 2 and/or 3 may also be applied to the battery module 200, the busbar assembly 220 (e.g., the busbar 221), and the sensor assembly 230 (e.g., the flexible printed circuit board 300) of FIGS. 4 and/or 5.

The sensor assembly 230 may be bonded to the busbar 221. For example, the flexible printed circuit board 300 of the sensor assembly 230 may be directly bonded to the busbar 221. For example, the flexible printed circuit board 300 may include a metal layer 310 including a bent region 311 bonded to the busbar 221. Current from the busbar 221 may be transmitted to the sensor assembly 230 through the metal layer 310. In an embodiment, the metal layer 310 may include a conductive metal (e.g., copper).

The bent region 311 ensures sufficient thickness for welding the busbar 221 and the metal layer 310. The bent region 311 may increase the welding stability of the busbar 221 and the metal layer 310.

The bent region 311 may be formed by bending and/or pressing a single metal layer 310. The bent region 311 may eliminate the need for a separate metal layer (e.g., copper foil) for welding with the metal layer 310. By eliminating the need for a separate metal layer, the manufacturing cost of the battery module 200 may be reduced. By eliminating the need for a separate process for bonding the metal layer, the manufacturing difficulty of the battery module 200 may be reduced.

Since the bent region 311 of the metal layer 310 is directly welded to the busbar 221, a sensing terminal connecting the flexible printed circuit board 300 and the busbar 221 may not be necessary. By eliminating the need for the sensing terminal, the manufacturing costs of the battery module 200 may be reduced, and a separate process for bonding the sensing terminal may not be necessary.

The flexible printed circuit board 300 may include an insulating layer 320 covering at least a portion of the metal layer 310. The insulating layer 320 may protect the metal layer 310. The insulating layer 320 may prevent unintended contact between the metal layer 310 and a conductor. In an embodiment, the insulating layer 320 may include an insulating polymer (e.g., polyimide).

The metal layer 310 may include an end region 312 located on one side of the bend region 311 and a connection region 313 located on the other side of the bend region 311. The insulating layer 320 may cover the end region 312 of the metal layer 310. For example, the insulating layer 320 may include a first cover region 321 covering the end region 312 and a second cover region 322 covering the connection region. By covering the end region 312 of the metal layer 310 with the insulating layer 320, the structural stability and rigidity of the sensor assembly 230 may be enhanced. For example, the tensile strength of the flexible printed circuit board 300 may be increased by the insulating layer 320.

By covering the end region 312 of the metal layer 310 with the insulating layer 320, the manufacturing convenience of the sensor assembly 230 may be increased. For example, the flexible printed circuit board 300 may be folded when the insulating layer 320 is in contact with a worker or a work device. Since the flexible printed circuit board 300 is bent by using the first cover region 321 of the insulating layer 320 instead of the metal layer 310, process stability may be increased.

By covering the end region 312 of the metal layer 310 with the insulating layer 320, welding stability may be increased. For example, the insulating layer 320 may prevent the welding spot W from moving to an unintended location.

The metal layer 310 may include a first surface 310a and a second surface 310b opposite to the first surface 310a. At least a portion of the metal layer 310 may be folded. For example, at least a portion of the first surface 310a may be folded such that at least a portion thereof contacts each other. The metal layer 310 may be bonded to the busbar 221. For example, at least a portion of the second surface 310b may be bonded to the busbar 221. In an embodiment, the first surface 310a of the bent region 311 may be folded so that at least a portion thereof contacts each other in a facing manner. Through this, the bent region 311 may be disposed such that at least a portion thereof overlaps each other when folded based on the folding line FL.

The insulating layer 320 may cover upper and lower portions of the end region 312 and/or the connection region 313. For example, the first cover region 321 may include a first insulating layer 323 covering the first surface 310a of the end region 312 and a second insulating layer 324 covering the second surface 310b of the end region 312. The second cover region 322 may include a third insulating layer 325 covering the first surface 310a of the connection region 313 and a fourth insulating layer 326 covering the second surface 310b of the connection region 313. Due to the plurality of insulating layers 323, 324, 325, and 326, a short-circuit of and damage to the metal layer 310 may be prevented. In an embodiment, the insulating layer 320 may cover the metal layer 310 such that at least one of the first surface 310a and the second surface 310b of the metal layer 310 is exposed. More specifically, the insulating layer 320 may cover the metal layer 310 such that at least a portion of the first surface 310a of the bent region 311 and at least a portion of the second surface 310b of the bent region 311 are exposed.

The first insulating layer 323 may be in contact with the third insulating layer 325. For example, in a bent flexible printed circuit board 300, the end region 312 and the first cover region 321 may be disposed over the connection region 313 and the second cover region 322. By bringing the first insulating layer 323 into contact with the third insulating layer 325, the structural stability of the flexible printed circuit board 300 may be increased.

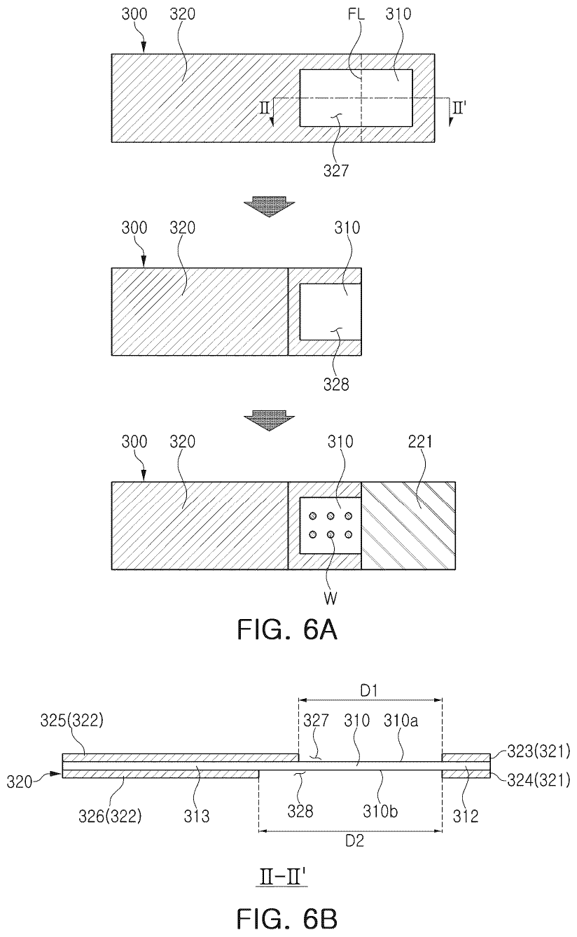

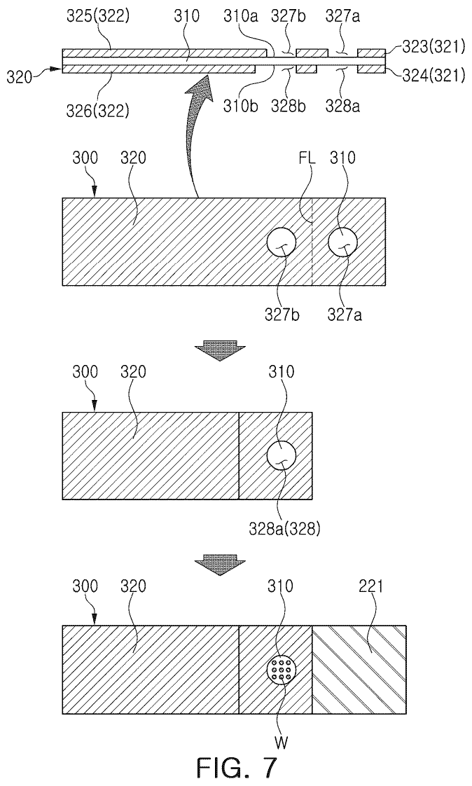

FIG. 6A is a diagram illustrating a process of connecting a sensor assembly and a busbar according to an embodiment. FIG. 6B is a cross-sectional view taken along line II-II′ of FIG. 6A. FIG. 7 is a diagram illustrating a process of connecting a sensor assembly and a busbar according to another embodiment.

Referring to FIGS. 6A, 6B, and/or 7, along with FIGS. 4 and 5, the flexible printed circuit board 300 may include the metal layer 310 and the insulating layer 320.

A portion of the metal layer 310 may be exposed to the outside of the insulating layer 320. The portion of the metal layer 310 exposed to the outside of the insulating layer 320 may be referred to as a land region. For example, the metal layer 310 exposed to the outside of the insulating layer 320 may be bonded to the busbar 221. In an embodiment, the insulating layer 320 may include an upper through-hole 327 exposing the first surface 310a of the metal layer 310 and a lower through-hole 328 exposing the second surface 310b of the metal layer 310. The upper through-hole 327 and the lower through-hole 328 may be formed by removing the insulating layer 320. According to an embodiment, the insulating layer 320 may include the upper through-hole 327 exposing at least a portion of the first surface 310a of the bent region 311 and the lower through-hole 328 exposing at least a portion of the second surface 310b of the bent region 311. Here, the second surface 310b of the bent region 311 exposed through the lower through-hole 328 may contact the busbar 221.

The flexible printed circuit board 300 may be folded based on the folding line FL. For example, by bending the bent region 311 of the metal layer 310, the metal layer 310 and the insulating layer 320 may be folded so that the first cover region 321 faces the second cover region 322. In an embodiment, a first diameter D1 of the upper through-hole 327 may be smaller than a second diameter D2 of the lower through-hole 328. The first insulating layer 323 and the third insulating layer 325 may be folded to face each other. By forming the first diameter D1 smaller than the second diameter D2, the structural stability of the flexible printed circuit board 300 may be increased. In an embodiment, after the flexible printed circuit board 300 is folded, the bent region 311 may be pressed to maintain the shape thereof.

The flexible printed circuit board 300 may be welded (e.g., spot welded) to the busbar 221. For example, the bent region 311 of the metal layer 310 may be bonded to the busbar 221. By bending the metal layer 310, the thickness of the metal layer 310 for a welding spot W may be secured. The second surface 310b of the bent region 311 may be bonded to the busbar 221.

The shape and/or number of the upper through-holes 327 and the lower through-holes 328 may be selectively designed. In an embodiment (e.g., FIG. 6A), the flexible printed circuit board 300 may include one upper through-hole 327 and one lower through-hole 328. When the flexible printed circuit board 300 is folded along the folding line FL, the upper through-holes 327 may face each other. Through the upper through-holes 327, the first surfaces 310a of the metal layer 310 may face each other.

In an embodiment (e.g., FIG. 7), the flexible printed circuit board 300 may include a plurality of upper through-holes 327a and 327b and a plurality of lower through-holes 328a and 328b. For example, the upper through-hole 327 may include a first upper through-hole 327a and a second upper through-hole 327b, which are spaced apart from each other. The lower through-hole 328 may include a first lower through-hole 328a and a second lower through-hole 328b, which are spaced apart from each other. When the flexible printed circuit board 300 is folded along the folding line FL, the first upper through-hole 327a, the second upper through-hole 327b, the first lower through-hole 328a, and the second lower through-hole 328b may be arranged to overlap each other. Through the first upper through-hole 327a, the second upper through-hole 327b, the first lower through-hole 328a, and the second lower through-hole 328b, the first surfaces 310a of the metal layer 310 may face each other.

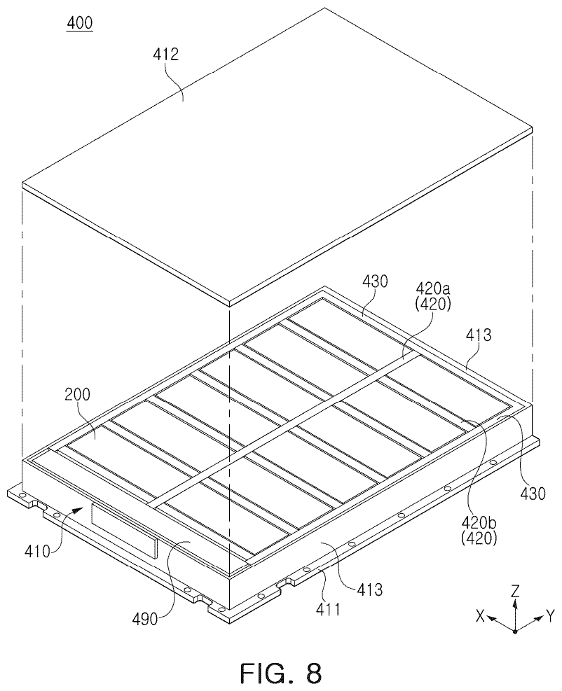

FIG. 8 is an exploded perspective view of a battery pack according to an embodiment.

Referring to FIG. 8, a battery pack 400 may include a plurality of battery modules 200 and a pack frame 410 accommodating the plurality of battery modules 200. The description of the battery module 200 given above may be applied to the battery module 200 of FIG. 8. For example, in an embodiment, the battery module 200 of FIG. 8 may include the flexible printed circuit board 231 of FIG. 3.

The pack frame 410 may accommodate components (e.g., the battery modules 200) of the battery pack 400. The pack frame 410 may include a bottom member 411 supporting the battery module 200, a pack cover 412 covering the battery module 200, and a pack sidewall 413 surrounding at least a portion of the bottom member 411 and the pack cover 412. The bottom member 411 may support the battery module 200.

The pack frame 410 may include a partition 420 crossing at least a portion of the plurality of battery modules 200. For example, an accommodation space of the pack frame 410 may be divided into a plurality of spaces by the partition 420. The partition 420 may be installed across the accommodation space to reinforce the rigidity of the pack frame 410. In an embodiment, the partition 420 may include a first partition 420a crossing the plurality of battery cells 100 and a plurality of second partitions 420b substantially perpendicular to the first partition 420a.

In an embodiment, the battery pack 400 may include a duct member 430. The duct member 430 may include an exhaust space to provide a path for gases and/or flames discharged from the battery module 200. The duct member 430 may be disposed within the pack frame 410. The duct member 430 may surround at least a portion of the battery module 200. For example, gases and/or flames generated in the battery cells (e.g., the battery cell 100 of FIG. 1) of the battery module 200 may pass through the exhaust space of the duct member 430 and be transmitted to the outside of the battery pack 400. In the present disclosure, the duct member 430 may be referred to as an exhaust duct or exhaust member.

The battery pack 400 may include a battery controller 490 controlling the battery module 200. The battery controller 490 may be disposed within the pack frame 410. The battery controller 490 may include a battery management system (BMS). The configuration of the battery controller 490 is well known in various forms, and thus, a detailed description thereof will be omitted. In an embodiment, the battery controller 490 may be referred to as a processor.

The structure of the battery pack 400 in FIG. 8 is an example. For example, the number of battery modules 200 included in the battery pack 400, the structure of the pack frame 410, and/or the duct member 430 may be selectively designed.

According to an embodiment of the present disclosure, the manufacturing costs of the battery module may be reduced.

According to an embodiment of the present disclosure, the manufacturing process of a battery module may be simplified.

The above-described contents are merely examples adopting the principles of the present disclosure, and other components may be further included without departing from the scope of the present disclosure

Although the embodiments of the present disclosure have been described above, the scope of the present disclosure is not limited thereto and it will be apparent to those skilled in the art that various modifications and variations may be made within the scope not departing from the technical idea of the present disclosure described in the claims. For example, the present disclosure may be implemented by deleting some of the components in the above-described embodiments, and the respective embodiments may be implemented in combination with each other.

What is claimed is:

1. A battery module comprising:
a cell assembly including a plurality of battery cells, each including at least one electrode lead;
a module housing accommodating the cell assembly;
a busbar assembly including a busbar bonded to the electrode leads of the cell assembly and a busbar frame supporting the busbar; and
a sensor assembly at least partially disposed on the busbar frame,
wherein the sensor assembly includes a flexible printed circuit board including a metal layer including a bent region bonded to the busbar and an insulating layer covering at least a portion of the metal layer.

2. The battery module of claim 1, wherein
the metal layer includes an end region located on one side of the bent region and a connection region located on the other side of the bent region, and
the insulating layer includes a first cover region covering the end region and a second cover region covering the connection region.

3. The battery module of claim 2, wherein the metal layer includes a first surface and a second surface, opposite to the first surface, and the first surface is folded such that at least a portion of the first surface contacts each other, and at least a portion of the second surface is bonded to the busbar.

4. The battery module of claim 3, wherein
the first cover region includes a first insulating layer covering the first surface of the end region and a second insulating layer covering the second surface of the end region, and
the second cover region includes a third insulating layer covering the first surface of the connection region and a fourth insulating layer covering the second surface of the connection region.

5. The battery module of claim 4, wherein the first insulating layer is in contact with the third insulating layer.

6. The battery module of claim 3, wherein the insulating layer includes an upper through-hole exposing the first surface of the metal layer and a lower through-hole exposing the second surface of the metal layer.

7. The battery module of claim 6, wherein a first diameter of the upper through-hole is smaller than a second diameter of the lower through-hole.

8. The battery module of claim 6, wherein
the upper through-hole includes a first upper through-hole and a second upper through-hole spaced apart from each other,
the lower through-hole includes a first lower through-hole and a second lower through-hole spaced apart from each other, and
the first upper through-hole, the second upper through-hole, the first lower through-hole, and the second lower through-hole are arranged to overlap each other.

9. The battery module of claim 1, wherein the metal layer includes copper, and the insulating layer includes polyimide.

10. The battery module of claim 1, wherein the plurality of battery cells each includes an electrode assembly connected to the electrode leads of the cell assembly and a pouch accommodating the electrode assembly.

11. The battery module of claim 1, wherein the sensor assembly includes a connection portion electrically connected to the flexible printed circuit board and an insulating portion preventing contact between the connection portion and the cell assembly.

12. A battery module comprising:
a plurality of battery cells;
a busbar electrically connected to at least one of the plurality of battery cells; and
a flexible printed circuit board including a metal layer connected to the busbar and including a bent region folded along a folding line, and an insulating layer covering the metal layer such that at least a portion of the bent region is exposed,
wherein the at least a portion of the bent region exposed from the insulating layer is in contact with the busbar.

13. The battery module of claim 12, wherein
the metal layer includes a first surface opposite to the busbar and a second surface, opposite to the first surface and facing the busbar, and
the first surface of the bent region is folded such that at least a portion of the first surface contacts each other in a facing manner.

14. The battery module of claim 13, wherein
the insulating layer includes an upper through-hole exposing at least a portion of the first surface of the bent region and a lower through-hole exposing at least a portion of the second surface of the bent region, and
the second surface of the bent region exposed through the lower through-hole contacts the busbar.

15. A battery pack comprising:
a plurality of battery modules; and
a pack frame accommodating the plurality of battery modules,
wherein the battery module includes:
a cell assembly including a plurality of battery cells, each including at least one electrode lead ;
a module housing accommodating the cell assembly;
a busbar assembly including a busbar bonded to the electrode leads of the cell assembly and a busbar frame supporting the busbar; and
a sensor assembly disposed on the busbar frame,
wherein the sensor assembly includes a flexible printed circuit board including a metal layer including a bent region bonded to the busbar and an insulating layer covering at least a portion of the metal layer.

16. The battery pack of claim 15, wherein
the metal layer includes a first surface opposite to the busbar and a second surface, opposite to the first surface and facing the busbar, and
the first surface of the bent region is folded such that at least a portion of the first surface contacts each other in a facing manner.

17. The battery pack of claim 16, wherein
the insulating layer includes an upper through-hole exposing at least a portion of the first surface of the bent region and a lower through-hole exposing at least a portion of the second surface of the bent region, and
the second surface of the bent region exposed through the lower through-hole contacts the busbar.
